(19) United States
(12) Patent Application Publication
(10) Pub. No.: US 2009/0211099 A1
(43) Pub. Date: Aug. 27, 2009

(54) RAZOR

(76) Inventor: Marie Elena Louis, Candler, NC (US)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/034,703

(22) Filed: Feb. 21, 2008

(51) Int. Cl. B26B 19/38

(52) U.S. Cl. 30/41

(57) ABSTRACT

This invention relates to a razor for reaching hard to reach areas on a body. A razor includes an extended handle, a head connected to the handle for shaving a desired area, and an applicator. The applicator cooperates with the head to provide a lubricant to the desired area and allow the head to efficiently shave the desired area.

### BACKGROUND OF THE INVENTION

The present invention relates generally to a razor, and more particularly to a razor with a long handle to allow users to shave areas on their body that they cannot easily reach.

For most people, shaving is an everyday occurrence, and in a lot of cases, is an easy task. For example, it takes relatively little effort for a man to shave his face. However, there are situations where shaving can be a daunting task, and in some instances almost impossible.

In general, women have a more difficult time shaving because of the long reach required when shaving their legs. This often results in women bending over in a shower, propping one leg up on a sink or edge of a tub, or sitting in a tub and bending to try and reach their ankles. All of these can be difficult and in some cases be dangerous due to falling or slipping.

Shaving can be an even more daunting task for women that are pregnant, making it extremely hard to bend or lift their legs, for an individual who is handicapped, or for an individual with back problems who has very little bending motion available to them. In these cases, shaving can be almost, if not impossible. Thus, there needs to be a way for these individuals to shave in a safe and easy manner.

### BRIEF SUMMARY OF THE INVENTION

These and other shortcomings of the prior art are addressed by the present invention, which provides a razor with a long handle to allow individuals to reach areas of their body without a great amount of effort.

According to one aspect of the present invention, a razor includes an extended handle; a head connected to the handle for shaving a desired area; and an applicator cooperating with the head to provide a lubricant to the desired area and allow the head to efficiently shave the desired area.

According to one aspect of the present invention, a razor adapted to reach areas of the body without bending or contorting the body includes an extended handle; a head connected to the handle having a plurality of blades for shaving a desired area; a container connected to the handle for containing a lubricant; and an applicator operably connected to the container for receiving the lubricant from the container and applying the lubricant to a desired area of a user's body.

According to another aspect of the present invention, a method for shaving hard to reach areas on a body includes the step of providing a razor having an extended handle; a head connected to the handle; and an applicator cooperating with the head. The method further includes coating the applicator with a shaving lubricant; applying the lubricant to an area of the body; and shaving the area with the head.

### BRIEF DESCRIPTION OF THE DRAWINGS

The subject matter that is regarded as the invention may be best understood by reference to the following description taken in conjunction with the accompanying drawing figures in which:

FIG. 1 shows a razor according to an embodiment of the invention;

FIG. 2 shows a collapsible handle of the razor of FIG. 1;

FIG. 3 shows a razor according to an embodiment of the invention;

FIG. 4 shows a head of the razor of FIG. 3;

FIG. 5 shows a razor according to an embodiment of the invention; and

FIG. 6 shows an applicator of the razor of FIG. 5.

### DETAILED DESCRIPTION OF THE INVENTION

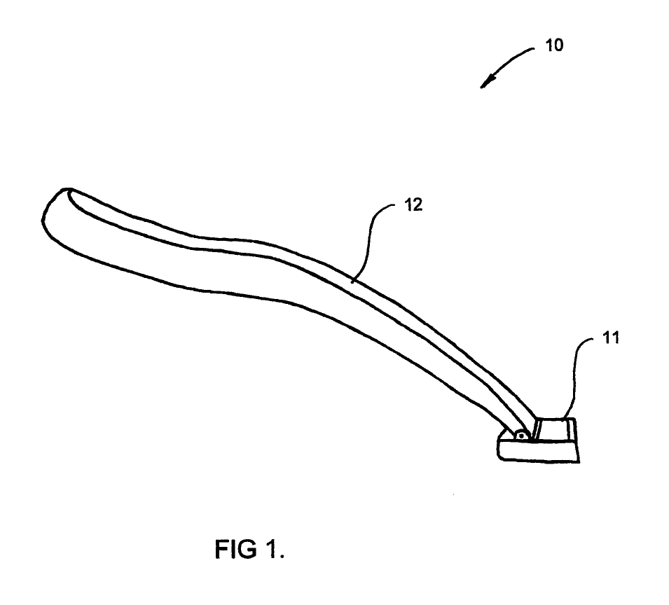

Referring to the drawings, an exemplary razor according to an embodiment of the invention is illustrated in FIG. 1 and shown generally at reference numeral 10. The razor 10 includes a detachable head 11 and an extended handle 12 to allow a user to reach areas of the body that otherwise would require the user to bend or contort their body to reach. Due to the added length of the handle 12, the handle 12 is shaped to allow a user to apply the proper amount of pressure to the head 11 to allow the head 11 to efficiently shave the desired area of the body.

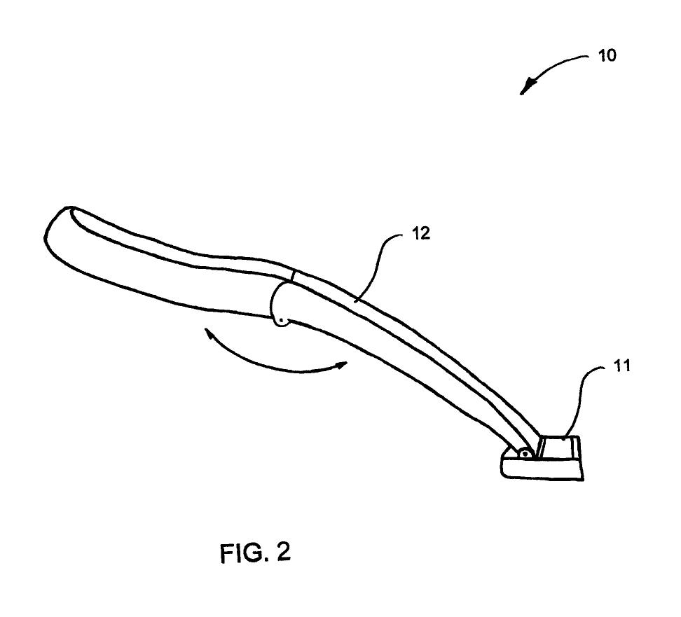

As shown in FIG. 2, the handle 12 may be collapsible to allow the razor to be stored or carried in a travel pouch. The handle 12 may be collapsed by folding the handle, as shown, by an accordion effect where the handle 12 collapses into itself, or by any other suitable means.

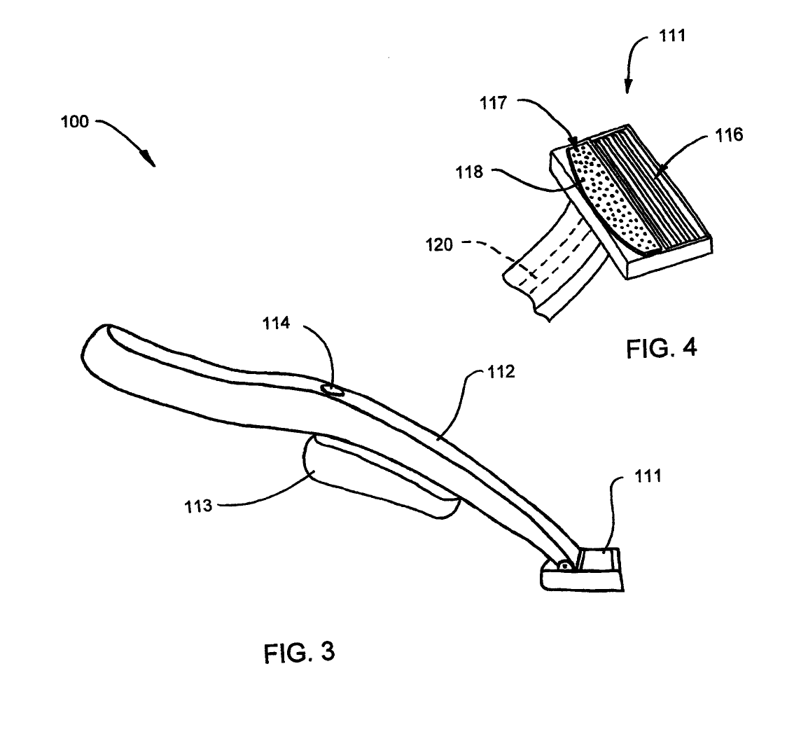

Referring to FIG. 3, a razor according to an embodiment of the invention is illustrated and shown generally at reference numeral 100. Like razor 10, razor 100 includes a head 111 and an extended handle 112. Razor 100 further includes a container 113 connected to the handle 112 for containing a shaving lubricant such as gel or cream, and an actuator 114 disposed on the handle 112 to release the lubricant for use by the user. It should be appreciated that the container 113 may be fixedly or detachably connected to the handle 112. As shown in FIG. 4, the head 111 includes a plurality of blades 116 and an applicator 117 for applying the lubricant released from the container 113. The applicator 117 includes a plurality of pores 118 to allow the lubricant to coat the applicator 117, thereby allowing the user to apply the lubricant to the area of the body being shaved.

In use, a user depresses the actuator 114 to release the lubricant from the container 113. The lubricant flows through at least one tube or pathway 120 to the applicator 117 where the lubricant is dispersed through the pores 118 onto the applicator 117. Once the applicator 117 is coated with lubricant, the user uses the applicator to apply the lubricant to the area of the body being shaved. It should be appreciated that the lubricant could be applied prior to shaving by angling the head 111 of the razor 100 or the lubricant step and shaving step could be performed contemporaneously.

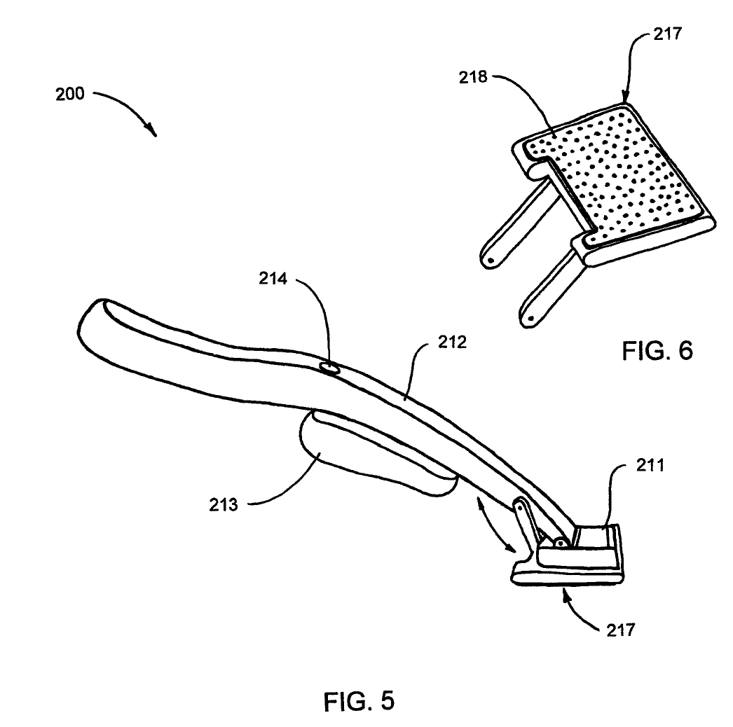

A razor 200 according to an embodiment of the invention is illustrated and shown in FIGS. 5 and 6. Like razor 100, razor 200 includes a head 211 having blades (not shown), a handle 212, a container 213, and an actuator 214. Unlike razor 100, an applicator is not positioned on the head 211. Instead, razor 200 includes a separate applicator 217 having pores 218 that is connected to the handle 212 and adapted for movement between a use position and a non-use position.

As shown, the applicator 217 is pivotally connected to the handle 212 to allow a user to pivot the applicator 217 from the use position to the non-use position. This allows the applicator 217 to have a larger applying area so that a greater amount of lubricant can be applied easily without the applicator 217 interfering with the blades of the head 211. In use, the user pivots the applicator 217 to the use position so that the applicator 217 covers and operates in place of the head 211. The user then depresses the actuator 214 to release a lubricant from the container 213 into a pathway (not shown) where the lubricant is delivered to the applicator 217. The lubricant is then released onto the applicator 217 through the pores 218. Once the lubricant has been applied, the applicator 217 is pivoted to the non-use position to allow the head 211 to shave the desired area.

The foregoing has described a razor. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A razor, comprising:
(a) an extended handle;
(b) a head connected to the handle for shaving a desired area; and
(c) an applicator cooperating with the head to provide a lubricant to the desired area and allow the head to efficiently shave the desired area.

2. The razor according to claim 1, wherein the applicator is positioned on the head.

3. The razor according to claim 1, wherein the applicator includes pores adapted to allow the lubricant to flow therethrough and onto the applicator.

4. The razor according to claim 1, further including a container adapted to contain a lubricant therein.

5. The razor according to claim 4, further including an actuator operably connected to the container to release the lubricant contained therein and allow the lubricant to flow through pores and coat the applicator.

6. The razor according to claim 1, wherein the applicator is pivotally connected to the handle and adapted for movement between a use position where lubricant is applied to the desired area and a non-use position.

7. The razor according to claim 1, wherein the handle has a curvature to allow a user to apply pressure to the head and allow the head to efficiently shave the desired area.

8. A razor adapted to reach areas of the body without bending or contorting the body, comprising:
(a) an extended handle;
(b) a head connected to the handle having a plurality of blades for shaving a desired area;
(c) a container connected to the handle for containing a lubricant; and
(c) an applicator operably connected to the container for receiving the lubricant from the container and applying the lubricant to a desired area of a user's body.

9. The razor according to claim 8, wherein the applicator is positioned on the head and includes pores adapted to allow the lubricant to coat the applicator.

10. The razor according to claim 8, further including an actuator operably connected to the container and adapted to release the lubricant from the container to allow the lubricant to coat the applicator.

11. The razor according to claim 8, wherein the applicator includes pores adapted to allow the lubricant to coat the applicator, the applicator being pivotally connected to the handle and adapted for movement between a use position where lubricant is applied to the desired area and a non-use position where the head shaves the desired area.

12. A method for shaving hard to reach areas on a body, comprising the steps of:
(a) providing a razor having:
(i) an extended handle;
(ii) a head connected to the handle; and
(iii) an applicator cooperating with the head;
(b) coating the applicator with a shaving lubricant;
(c) applying the lubricant to an area of the body; and
(d) shaving the area with the head.

13. The method according to claim 12, wherein the razor further includes a container connected to the razor for containing the lubricant.

14. The method according to claim 13, further including the step of releasing the lubricant from the container to coat the applicator.

15. The method according to claim 14, further including the step of depressing an actuator on the handle to release the lubricant from the container.

16. The method according to claim 12, further including the step of pivoting the applicator from a non-use position to a use position.

17. The method according to claim 12, further including the step of pivoting the applicator from the use position to the non-use position.
